(19) United States
(12) Patent Application Publication
(10) Pub. No.: US 2015/0041305 A1
(43) Pub. Date: Feb. 12, 2015

(54) INTEGRATED ETHANOL AND RENEWABLE DIESEL FACILITY

(71) Applicant: WB Technologies LLC, Sedgwick, KS (US)

(72) Inventors: Rachel Overheul, Sedgwick, KS (US); Bowe Wingerd, Sedgwick, KS (US)

(73) Assignee: WB Technologies LLC, Sedgwick, KS (US)

(21) Appl. No.: 14/081,767

(22) Filed: Nov. 15, 2013

Related U.S. Application Data
(63) Continuation of application No. 13/963,516, filed on Aug. 9, 2013.

(51) Int. Cl. C10G 1/00; C12G 3/12

(52) U.S. Cl. CPC C10G 1/006; C12G 3/12
USPC 202/176; 585/240; 422/187; 426/494

(57) ABSTRACT

An integrated facility for the co-production of ethanol and renewable diesel fuel is provided. Corn oil, an ethanol production by-product, is utilized as a feedstock for a renewable diesel plant operating within the same general facility as the corn ethanol plant. By-products of the renewable diesel plant, such as fuel gas, steam, and/or naphtha, can be utilized in various parts of the ethanol plant to increase the operating efficiency thereof.

### CROSS-REFERENCE TO RELATED APPLICATION

This application is a continuation of U.S. patent application Ser. No. 13/963,516, filed Aug. 9, 2013, which is incorporated herein in its entirety.

### BACKGROUND OF THE INVENTION

1. Field of the Invention

The present invention generally pertains to an integrated facility for the co-production of ethanol and renewable diesel fuel. In particular, corn oil isolated from the whole stillage of an ethanol distillation process is utilized as a feedstock for a renewable diesel plant operating within the same general facility as the corn ethanol plant. By-products of the renewable diesel plant, such as fuel gas, steam, and naphtha, can be utilized in various parts of the ethanol plant thereby increase the operating efficiency thereof.

2. Description of the Prior Art

Corn oil is a by-product of a corn ethanol production. The corn oil is generally carried through the fermentation and distillation portions of a corn ethanol plant into the whole stillage that is removed from the distillation system. The whole stillage is commonly separated into a thin stillage, which includes the corn oil, and a cake that can be dried to produce dried distillers grains with solubles (DDGS), which can be used as an animal feed. The thin stillage can be processed to remove moisture therefrom and form nutritive syrup that can also be used as an animal feed material. Alternatively, the corn oil may be extracted from the thin stillage and be made a saleable product.

The corn oil extracted from the thin still has many industrial uses, such as in soaps, paints, rustproofing materials, inks, textiles, and insecticides. Corn oil can also be used as a feedstock in the production of alternative fuels such as biodiesel and renewable diesel. Biodiesel refers to a vegetable oil- or animal fat-based diesel fuel comprising long-chain alkyl (methyl, ethyl, or propyl) esters. Biodiesel is generally not considered to be a full replacement of conventional petrodiesel for use in most diesel engines. Rather, it is generally blended with petrodiesel for use in the retail diesel fuel marketplace. Renewable diesel, on the other hand, is produced by hydrotreatment of corn oil, for example, resulting in a hydrocarbon fuel that is very similar to petroleum diesel in its chemical composition.

A number of reaction schemes exist for conversion of corn oil into renewable diesel. Hydrotreating is one such process in which the corn oil feedstock is reacted with hydrogen under elevated temperature and pressure to change the chemical composition of the feed-stock. In the case of renewable diesel, hydrogen is introduced to the feedstock in the presence of a catalyst convert the triglyceride molecules into paraffinic hydrocarbons. In addition to creating a fuel that is very similar to petrodiesel, this process creates other hydrocarbon by-products including lower hydrocarbon fuel gas compounds (e.g., methane, ethane, propane, and butane) and higher hydrocarbon naphtha. U.S. Patent Application Publication No. 2010/0155296, incorporated by reference herein in its entirety, discloses an exemplary renewable diesel system.

Generally, the corn oil feedstock is produced at a location remote from the renewable diesel facility, thus requiring transport of the corn oil via pipeline, railway tankers, or tanker trucks. This added transportation cost increases the overall expense in the manufacture of renewable diesel and decreases its competitiveness with petrodiesel as an alternative fuel source.

### SUMMARY OF THE INVENTION

Certain embodiments of the present invention seek to eliminate the foregoing drawbacks of conventional renewable diesel production by co-locating renewable diesel and corn ethanol production facilities. Not only does co-location of these facilities reduce transportation costs, but also permit further cost savings through integration of various by-products of renewable diesel production within the corn ethanol production facility.

In one embodiment of the present invention, there is provided an integrated process for the co-production of ethanol and renewable diesel fuel. The process comprises distilling an ethanol-containing beer within distillation apparatus of an ethanol plant to produce an ethanol-rich overhead stream and a solids-containing, whole stillage stream. Corn oil is recovered from the ethanol plant (e.g., through the use of whole stillage processing apparatus). The corn oil from the ethanol plant is then reacted with hydrogen in a reaction system of a renewable diesel plant to produce a mixture of reaction products comprising renewable diesel fuel, fuel gas, and naphtha. The reaction products are directed to a distillation system of the renewable diesel plant for separation of the reaction products into a renewable diesel fuel stream, a fuel gas stream, and a naphtha stream. At least a portion of the fuel gas stream is combusted within one or more devices located within or utilized during the operation of the ethanol plant.

In another embodiment of the present invention, there is provided an integrated process for the co-production of ethanol and renewable diesel fuel. An ethanol-containing beer is distilled within distillation apparatus of an ethanol plant to produce an ethanol-rich overhead stream and a solids-containing, whole stillage stream. Corn oil is recovered within the ethanol plant (e.g., via whole stillage processing apparatus). The corn oil from the ethanol plant is reacted with hydrogen in a reaction system of a renewable diesel plant to produce a mixture of reaction products comprising renewable diesel fuel, fuel gas, and naphtha. The reaction products are directed to a renewable diesel distillation system for separation of the reaction products into a renewable diesel fuel stream, a fuel gas stream, and a naphtha stream. At least a portion of the ethanol-rich overhead stream is condensed to produce an ethanol product stream. A least a portion of the naphtha stream is added to the ethanol product stream to produce a denatured ethanol product.

In yet another embodiment of the present invention, there is provided an integrated process for the co-production of ethanol and renewable diesel fuel. An ethanol-containing beer is distilled within distillation apparatus of an ethanol plant to produce an ethanol-rich overhead stream and a solids-containing, whole stillage stream. Corn oil is also recovered from the ethanol plant (e.g., via whole stillage processing apparatus). The corn oil from the ethanol plant is reacted with hydrogen in a reaction system of a renewable diesel plant to produce a mixture of reaction products comprising renewable diesel fuel, fuel gas, and naphtha. The reaction products are directed through a heat exchanger to cool the reaction products and generate steam. The cooled reaction products are directed a renewable diesel distillation system for separation of the reaction products into a renewable diesel fuel stream, a fuel gas stream, and a naphtha stream. The steam is directed to a steam distribution header for providing steam to the ethanol plant.

In still another embodiment of the present invention, there is provided an integrated facility for the co-production of ethanol and renewable diesel fuel. The facility comprises an ethanol plant and a renewable diesel plant. The ethanol plant comprises distillation apparatus operable to separate an ethanol-containing beer into an ethanol-rich overhead stream and a solids-containing, whole stillage stream, and corn oil recovery apparatus operable to produce a corn oil stream. The renewable diesel plant comprises a reaction system operably coupled with the corn oil recovery apparatus to receive at least a portion of the corn oil stream and produce a reaction product stream comprising renewable diesel fuel, naphtha, and fuel gas, and a distillation system operable to separate the reaction product stream into a renewable diesel fuel stream, a naphtha stream, and a fuel gas stream. The fuel gas stream is operably coupled with one or more fuel gas-combusting devices located within or utilized during operation of the ethanol plant.

### BRIEF DESCRIPTION OF THE DRAWINGS

FIG. 1 is diagram of an integrated ethanol and renewable diesel production facility according to one embodiment of the present invention; and

FIG. 2 is a detailed diagram of a renewable diesel plant that may be used in the facility of FIG. 1.

### DETAILED DESCRIPTION OF THE PREFERRED EMBODIMENT

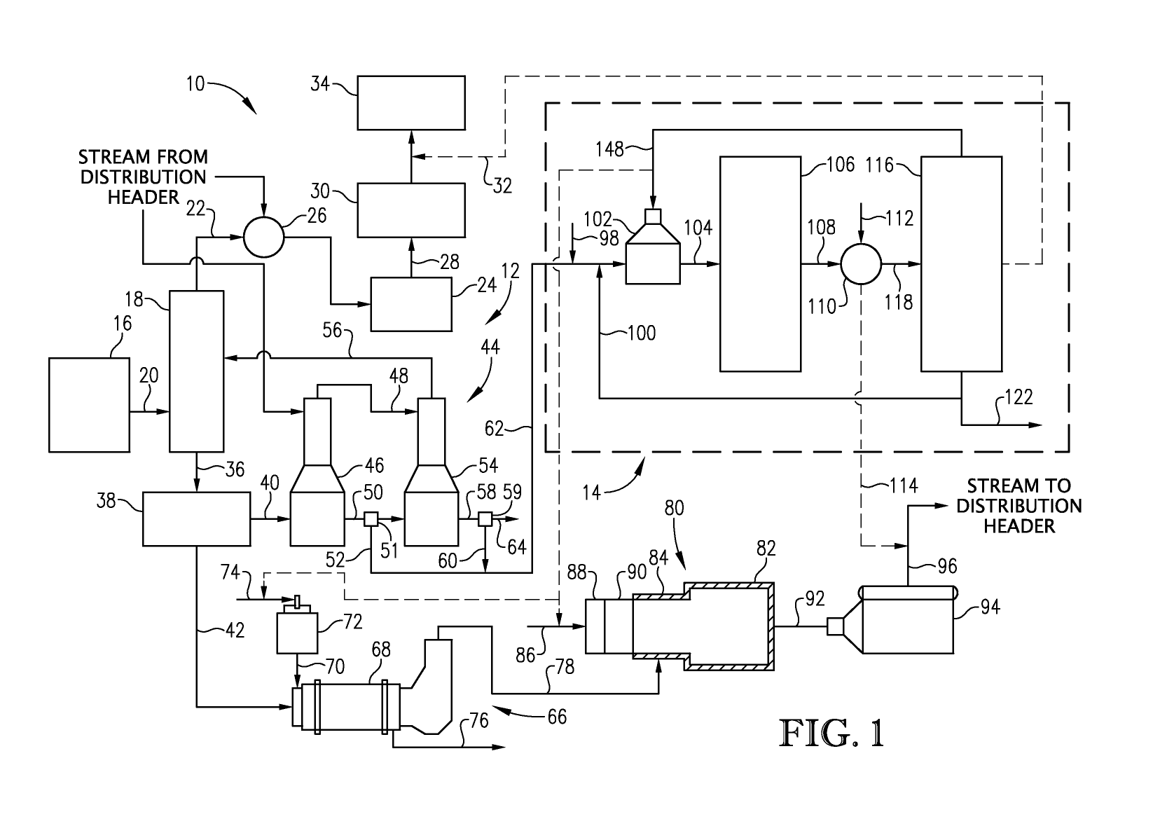

Turning to FIG. 1, an integrated ethanol and renewable diesel production facility 10 is illustrated. In particular, facility 10 comprises an ethanol plant 12 and a renewable diesel plant 14. In a departure from conventional practice, the ethanol plant 12 and renewable diesel plant 14 are co-located so that products and by-products of each facility may be readily shared thereby reducing the cost of facility operation.

Ethanol plant 12 can be configured in a conventional manner, with the biomass material undergoing initial processing and fermentation to produce an ethanol-containing “beer”. In particular embodiments, ethanol plant 12 utilizes a biomass material as the source of carbohydrate and sugar for the fermentation process. A plant or vegetable oil is an important by-product of ethanol plant 12, as this forms the feedstock to renewable diesel plant 14, it is preferable for the biomass material to contain suitable amounts of plant oil. Exemplary biomass feed materials for use with the present invention include corn, sorghum, and pearl millet. In the U.S., however, corn is the predominant feedstock for fuel ethanol production. Accordingly, the description set forth below is made with respect to corn and corn by-products. This description is exemplary and should not be taken as a limitation on the scope of the present invention.

The preparation and fermentation of the corn feedstock within ethanol plant 12 may be carried out according to any number of methods known to those of skill in the art and is not repeated herein. Following fermentation, the ethanol-containing beer may be stored within a beer well 16 while it awaits further processing. In certain embodiments, the beer comprises between about 10% to about 20% by volume ethanol, more preferably about 15% by volume ethanol, and between about 5% to about 20% by weight solids, more preferably about 10% by weight solids.

The beer is fed to distillation apparatus 18 via stream 20 for separation and recovery of the ethanol contained therein. Distillation apparatus 18, which may comprise one or more distillation columns, produces an overhead stream 22 comprising primarily ethanol and some water. In certain embodiments, overhead stream 22 comprises between about 80% to about 99% by volume ethanol, 90% to about 98% by volume ethanol, or about 95% by volume ethanol, with the balance comprising water. In order to be suitable for use as fuel-grade ethanol, the remaining water needs to be removed from the overhead stream. Further separation of the water from overhead stream 22 is accomplished by a dehydration unit 24. Dehydration unit 24 can be equipped with molecular sieve technology to achieve this separation. In certain embodiments, the molecular sieve comprises an alumino silicate material. In certain embodiments, stream 22 is condensed so that a portion can be refluxed back to apparatus 18, however, this need not always be the case. In those embodiments in which stream 22 was previously condensed, the stream should be vaporized before it is passed to dehydration unit 24. This vaporization can be accomplished by one or more heat exchangers 26 feed with steam supplied via a plant distribution header. A substantially pure ethanol stream 28 (i.e., greater than 99% by volume ethanol, or approximately 200 proof) exits dehydration unit 24 and is stored in a storage vessel 30 to await further processing. Government regulations require that prior to transport fuel grade ethanol (i.e., ethanol approaching 200 proof concentration) must be denatured or rendered non-potable. Generally, this is accomplished by adding about 2% sweet gasoline to the recovered ethanol. However, as explained in greater detail below, the present invention utilizes a by-product from renewable diesel plant 14, namely naphtha, for this purpose. The naphtha obtained from renewable diesel plant 14 may be added to the recovered ethanol via stream 32. In certain embodiments, the naphtha may be added to the recovered ethanol at a level of between about 0.5% to about 5% by volume, between about 1% to about 3% by volume, or about 2% by volume. The denatured ethanol product may be stored in a vessel 34 to await transportation away from facility 10.

The bottoms from distillation apparatus 18 comprises a whole stillage stream 36. Several products can be produced from whole stillage stream 36 including corn oil, a nutritive corn syrup, and dried distillers grains with solubles (DDGS). The whole stillage stream 36 may be separated by a centrifuge 38 into a thin stillage stream 40 and a cake 42. The thin stillage stream 40 generally comprises between about 5% to about 10% by weight solids, and more preferably about 7% by weight solids. The balance of the thin stillage comprises mainly water and corn oil. The thin stillage is concentrated within a multiple-effect evaporator 44. Steam from the steam distribution header is introduced into a first effect 46 in indirect heat exchange relationship with the thin stillage stream 40. Moisture is evaporated from the thin stillage and removed from first effect 46 as process steam stream 48. The concentrated stillage product 50 is removed from first effect 46 and a portion of the corn oil contained therein is separated as stream 52. The separation of the corn oil may be achieved through the use of a mechanical separation device 51. In certain embodiments, the separation device 51 may be a decanter system such as the TRICANTER from Flottweg Separation Technology, Gellnany, or a disc stack unit. The concentrated stillage product (minus the corn oil that was removed) is passed through a second effect 54 wherein steam from stream 48, through indirect heat exchange, causes a portion of the moisture contained within the concentrated stillage product to evaporate. This vapor is returned to distillation apparatus 18 via stream 56. The stillage product now comprises a viscous syrup and is withdrawn from the second effect 54 via stream 58. Additional corn oil is can be removed via stream 60 (if not removed via stream 52) through the use of a second separation device 59. The combined stream 62 comprises the feedstock for the renewable diesel plant 14. The syrup having the oil removed therefrom is recovered as a product stream 64.

In an alternate embodiment of the present invention, the corn oil may be extracted prior to fermentation. For example, the corn oil may be extracted via pressing or solvent extraction prior to fermentation. In such case, the processing of the thin stillage occurs as mentioned above, with the exception of corn oil recovery.

The cake 42 from centrifuge 38 is conveyed toward drying apparatus 66 in which moisture is removed and DDGS produced. Drying apparatus 66 comprises a dryer drum(s) 68 that is supplied by a hot air stream 70 from heater 72. Heater 72 comprises a burner that is fueled generally with a natural gas stream 74. However, as explained further below, in certain embodiments of the present invention, the natural gas can be supplemented or replaced with a fuel gas produced by the renewable diesel plant 14. The DDGS product is then removed from dryer 68 via stream 76. The exhaust gases 78 from dryer(s) 68 may comprise air pollutants, such as volatile organic compounds, that must be disposed of prior to being released into the atmosphere. Thermal oxidation apparatus 80 is generally provided for this purpose. As illustrated, apparatus 80 comprises a thermal oxidizer 82. The dryer exhaust gases 78 are heated by a burner located within a combustion chamber 84 fueled by a mixture of natural gas supplied by stream 86, a flue gas recycle 88 and combustion air 90. As explained in further detail below, the natural gas stream 86 may be supplemented or replaced by fuel gas produced by renewable diesel plant 14. In alternate embodiments, thermal oxidation apparatus 80 can comprise a regenerative thermal oxidizer if a higher degree of VOC removal is required. Waste heat from thermal oxidation apparatus 80 can be recovered from exhaust stream 92 and used to generate steam within steam generator 94. The steam produced by steam generator 94 can then be directed to the steam distribution header via stream 96 for use within facility 10.

As noted above the corn oil stream 62 comprises a feedstock for renewable diesel plant 14. Within renewable diesel plant 14, the triglycerides making up the corn oil feedstock 62 are converted into hydrocarbon compounds that are essentially chemically identical to those found in petrodiesel fuels. The reaction process involves hydrogenation of the fatty acids making up the triglycerides. The hydrogenation reaction is conducted at relatively high temperatures. Therefore, the reactants are generally heated prior to being introduced into the reactor. As illustrated, the corn oil stream 62 is combined with hydrogen gas supplied via stream 98 and diesel recycle stream 100 and then directed to a direct fired heater 102 where its temperature is raised to between about 500° to about 650° F., and more preferably to about 700° F. This heated reactants stream 104 is then directed to a reaction system 106. In certain embodiments, reaction system 106 utilizes two types of catalysts located in one or more reactors. One catalyst generally functions as a deoxygenating catalyst, and one catalyst as an isomerization catalyst. In certain embodiments, the catalysts may comprise molybdenum, and particularly alumina supported molybdenum. The reaction within reaction system 106 is exothermic, and therefore a temperature increase results as the reactants progress through the system. Care should be taken to ensure that the temperature does not become too high as thermal cracking of the products may occur and lead to fouling of the catalyst. Temperature control may be achieved through the use of a hydrogen quench system and diesel recycle.

The reaction products, which comprise the renewable diesel fuel, naphtha, and fuel gas are removed from reaction system 106 via stream 108. As the reaction products are at an elevated temperature, heat may be recovered therefrom and used to generate steam, which can then be utilized in other areas of facility 10. The reaction products may be passed through a heat exchanger 110 for this purpose. Water, preferably water that has been purified via reverse osmosis, may be supplied to heat exchanger 110 via stream 112 and steam produced. The steam may then be delivered to the steam distribution header via stream 114 where it can be combined with steam from steam generator 94. As previously noted, steam supplied by the steam distribution header can be used in various places throughout facility 10, and in particular within ethanol plant 12. By combining the steam from stream 114 with steam produced by steam generator 94, at least a portion of the steam generated within the renewable diesel plant 14 can be utilized within ethanol plant 12, such as in heat exchanger 26 or in the multiple effect evaporator 44, thereby decreasing the need for steam generation with external energy input. It is understood that steam generated within renewable diesel plant 14 may be utilized for other purposes within facility 10, and in particular, ethanol plant 12. For example, the steam may be used to supply heat for hydroheaters, evaporators, distillation columns, vaporizers, tank heaters, dryers, and utility steam heaters utilized within facility 10.

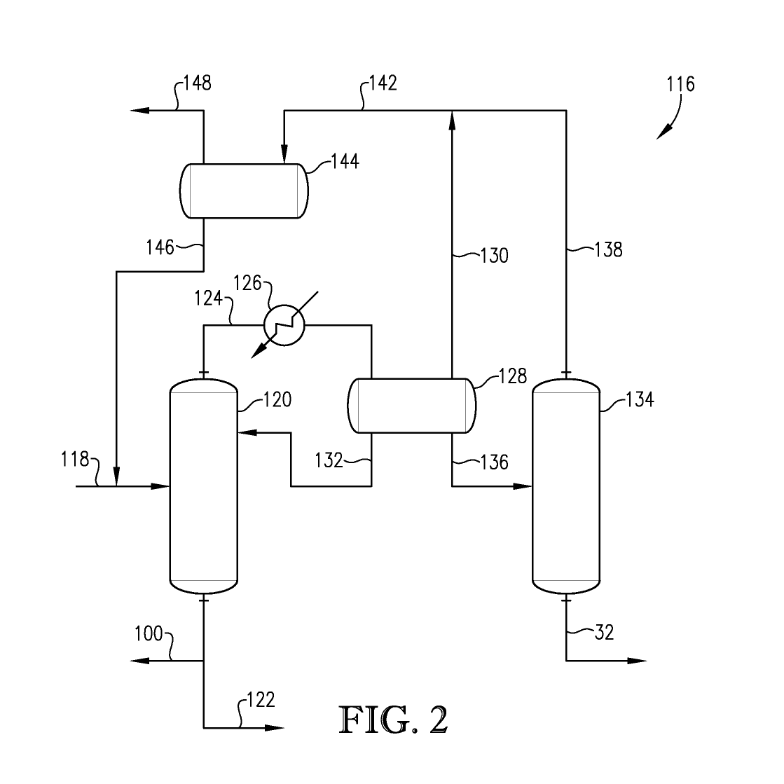

The cooled reaction products are then directed toward a distillation system 116 via stream 118 for separation and recovery of the various reaction product components. Turning to FIG. 2, one embodiment of distillation system 116 is shown in further detail. Cooled reactant products stream 118 is fed to a first distillation column 120 wherein a renewable diesel fuel product meeting the requirements of ASTM D975 is recovered via bottoms stream 122. As previously noted, a slipstream of diesel fuel 100 may be recycled upstream of the reaction system 106. The overhead stream 124, which comprises naphtha and fuel gas components can be at least partially condensed by condenser 126 and delivered to a separation vessel 128 where the fuel gas components in the vapor phase can be removed via stream 130 and a portion of the liquid refluxed to column 120 via stream 132 and another portion fed to a second distillation column 134 via stream 136. Within column 134, the remaining fuel gas is separated from the naphtha. The fuel gas overhead is removed via stream 138 and the naphtha product via bottoms stream 32. Fuel gas streams 130 and 138 may be combined to form stream 142 and directed to a fuel gas separator vessel 144. Within separator vessel 144, any condensable components, such as residual diesel and naphtha that might be present within fuel gas stream 142 can be separated and recycled to reactant products stream 118 via stream 146. The fuel gas is recovered from vessel 144 via stream 148 and can be used within facility 10 as described below. As noted above, the fuel gas may comprise a mixture of C1-C4 hydrocarbon compounds, such as methane, ethane, propane, and butane. The formation of these lower hydrocarbons is the result of cracking of larger hydrocarbon molecules within reactor system 106.

In one embodiment of the present invention, at least a portion of naphtha stream 32, which may comprise any number of C5-C12 hydrocarbon compounds, may be combined with the ethanol from storage vessel 30 to provide a denatured ethanol product as described above. It is understood that the naphtha denaturant may be added to the ethanol recovered from dehydration unit 24 at any processing point prior to shipment. For example, the naphtha may be added directly to the ethanol stream 28 from dehydration unit 24, directly to ethanol storage tank 30, or while transferring the ethanol to a vessel for storage or shipment. Any excess naphtha recovered may be considered a salable product and disposed of accordingly.

In another embodiment of the present invention, the fuel gas stream 148 may be utilized as a replacement for the natural gas fuel requirements of various devices utilized within facility 10. For example, fuel gas stream by be directed, at least in part, to heater 102 within renewable diesel plant 14, to the burner of thermal oxidizing apparatus 80, and/or to the burner of air heater 72. The fuel gas may be sufficient to replace at least some of the natural gas fuel requirements of one or more these devices. There may be additional devices, which are not shown, but could be present within facility 10 that could also make use of the fuel gas supplied by stream 148. For example, the fuel gas may be combusted within a gas turbine of a generator for generating electricity to be used by various control systems within ethanol plant 12 or renewable diesel plant 14. The fuel gas could also be utilized to generate additional steam, such as in a boiler (e.g., a package boiler as may be found in a plant employing a regenerative thermal oxidizer) if such was required.

It is understood that the various integrations between renewable diesel plant 14 and ethanol plant 12 described above, may be carried out all together, individually, or in any combination thereof as the requirements of any given facility 10 dictate. However, in preferred embodiments, full advantage of the naphtha, fuel gas and steam produced within renewable diesel plant 14 is taken within ethanol plant 12 thereby providing significant cost savings in the operation thereof.

I claim:

1. An integrated process for the co-production of ethanol and renewable diesel fuel comprising:
distilling an ethanol-containing beer within distillation apparatus of an ethanol plant to produce an ethanol-rich overhead stream and a solids-containing, whole stillage stream;
recovering a corn oil product from said ethanol plant, and directing a stream of said corn oil product to a renewable diesel plant; and
reacting said corn oil product stream received from said ethanol plant with hydrogen in a reaction system of said renewable diesel plant to produce a mixture of reaction products comprising renewable diesel fuel, fuel gas, and naphtha.

2. The process according to claims 1, including the steps of directing said reaction products to a distillation system of said renewable diesel plant, and separating said reaction products into a renewable diesel fuel stream, a fuel gas stream, and a naphtha stream.

3. The process according to claim 2, including the step of combusting at least a portion of said fuel gas stream within one or more devices located within or utilized during the operation of said ethanol plant and/or said renewable diesel plant.

4. The process according to claim 3, wherein said renewable diesel plant comprises a reactants heater located upstream of said reaction system, said reactants heater combusting at least a portion of said fuel gas stream to supply heat to said corn oil product and hydrogen entering said reaction system.

5. The process according to claim 1, wherein said corn oil product is recovered from said whole stillage stream within whole stillage processing apparatus of said ethanol plant, said whole stillage processing apparatus comprising a centrifuge for separating said whole stillage stream from said distillation apparatus into a thin stillage stream comprising said corn oil product and a cake, said cake being directed toward drying apparatus comprising a cake dryer and a thermal oxidizer for treatment of a dryer exhaust stream produced by said dryer.

6. The process according to claim 5, wherein said cake dryer is supplied with hot air from an air heater, said process comprising the steps of recovering a fuel gas stream from said renewable diesel plant, and combusting at least a portion of said fuel gas stream within said air heater.

7. The process according to claim 1, said process comprising the steps of recovering a fuel gas stream from said renewable diesel plant, wherein said ethanol plant is supplied with electrical power from a gas turbine, at least a portion of said fuel gas stream being combusted within said gas turbine.

8. The process according to claim 1, wherein at least a portion of said ethanol-rich overhead stream is condensed to produce an ethanol product stream, said ethanol product stream is then dehydrated to form an enriched ethanol product stream, naphtha is recovered from said renewable diesel plant, and said naphtha stream is added to said enriched ethanol product stream to produce a denatured ethanol product.

9. The process according to claim 1, including the steps of:
directing said reaction products through a heat exchanger to cool said reaction products and generate steam;
directing said cooled reaction products to a renewable diesel distillation system for separation of said reaction products into a renewable diesel fuel stream, a fuel gas stream, and a naphtha stream; and
directing said steam to a steam distribution header for providing steam to said ethanol plant.

10. The process according to claim 9, wherein said corn oil product is recovered from said whole stillage stream within whole stillage processing apparatus of said ethanol plant, said whole stillage processing apparatus comprising a centrifuge for separating said whole stillage stream from said distillation apparatus into a thin stillage stream comprising said corn oil product and a cake, said ethanol plant further comprising a multiple effect evaporator, said thin stillage stream is directed through said multiple effect evaporator to remove moisture therefrom and form a syrup, said steam distribution header is operably connected to a first effect of said multiple effect evaporator, including the step of delivering at least a portion of said steam to said first effect.

11. The process according to claim 10, wherein said ethanol-rich overhead stream is condensed and directed through an overhead heat exchanger that is operably coupled with said steam distribution header, at least a portion of said steam being directed through said overhead heat exchanger to evaporate at least a portion of said condensed ethanol-rich overhead stream to form an evaporated ethanol-rich stream.

12. An integrated facility for the co-production of ethanol and renewable diesel fuel comprising:
an ethanol plant comprising-
distillation apparatus operable to separate an ethanol-containing beer into an ethanol-rich overhead stream and a solids-containing, whole stillage stream; and
corn oil recovery apparatus operable to produce a corn oil stream; and
a renewable diesel plant comprising-
a reaction system operably coupled with said corn oil recovery apparatus to receive at least a portion of said corn oil stream and produce a reaction product stream comprising renewable diesel fuel, naphtha, and fuel gas.

13. The integrated facility according to claim 12, said renewable diesel plant further comprising a distillation system operable to separate said reaction product stream into a renewable diesel fuel stream, a naphtha stream, and a fuel gas stream.

14. The integrated facility according to claim 13, said fuel gas stream being operably coupled with one or more fuel gas-combusting devices located within or utilized during operation of said ethanol plant and/or said renewable diesel plant.

15. The integrated facility according to claim 12, wherein said renewable diesel plant includes a reactants heat exchanger disposed downstream of said reaction system and upstream of said distillation system, said reactants heat exchanger operable to generate steam that is directed to a steam distribution header.

16. The integrated facility according to claim 12, wherein said corn oil recovery apparatus comprises whole stillage processing apparatus operable to produce said corn oil stream and a distillers grain product, said whole stillage process apparatus comprising a centrifuge operable to separate a whole stillage stream from said distillation apparatus into a thin stillage stream and a cake, and a multiple effect evaporator operable to produce a syrup from said thin stillage stream, said steam distribution header being operably coupled with a first effect of said multiple effect evaporator, steam generated by said reactants heat exchanger being directed to said first effect.

17. The integrated facility according to claim 16, wherein said ethanol plant comprises an overhead heat exchanger operable to receive at least a portion of said ethanol-rich overhead stream and evaporate at least a portion thereof, said overhead heat exchanger being operably coupled with said steam distribution header, steam generated by said reactants heat exchanger being directed to said overhead heat exchanger.

18. The integrated facility according to claim 12, wherein said ethanol plant comprises a dehydration unit operable to remove water from said ethanol-rich overhead stream and produce an enriched ethanol product stream, at least a portion of said naphtha from said renewable diesel plant being directed toward and combined with at least a portion of said enriched ethanol product stream to produce a denatured ethanol product.

19. The integrated facility according to claim 14, wherein said one or more fuel gas-combusting devices are selected from the group consisting of:
(a) a thermal oxidizer burner operably connected to thermal oxidizer apparatus receiving a cake dryer exhaust gas stream;
(b) a cake dryer air heater operably connected with a cake dryer; and
(c) a gas turbine; and
(d) a boiler.

20. The integrated facility according to claim 12, including a conveying conduit serving to transfer said corn oil stream from said ethanol plant to said renewable diesel plant.
